(19) United States
(12) Patent Application Publication
(10) Pub. No.: US 2025/0256867 A1
(43) Pub. Date: Aug. 14, 2025

(54) Re-Configurable VTOL Aircraft

(71) Applicant: Delhivery Robotics LLC, Sunnyvale, CA (US)

(72) Inventors: Jeff Gibboney, Menlo Park, CA (US); Pranay Sinha, Sunnyvale, CA (US); Christopher Forrette, Ben Lomond, CA (US)

(21) Appl. No.: 18/621,047

(22) Filed: Mar. 28, 2024

Related U.S. Application Data
(60) Provisional application No. 63/463,424, filed on May 2, 2023.

(51) Int. Cl. B64U 10/20; B64C 3/18; B64F 5/10; B64U 20/50

(52) U.S. Cl. CPC B64U 10/20; B64C 3/185; B64F 5/10; B64U 20/50

(57) ABSTRACT

A manned/unmanned aerial vehicle adapted for vertical takeoff and landing which is configured to be easily disassembled and reassembled. The aerial vehicle may be assembled with different wings based upon flight needs, which may be based upon cargo mass and flight duration, for example. The aerial vehicle may utilize structural booms within components, and may allow for decoupling of boom sections to facilitate disassembly. The aerial vehicle may utilize electric motors and store power in batteries. A method of customizing a configuration of an unmanned aerial vehicle based upon flight profile factors such as duration, stability, and maneuverability. A method of disassembling an aerial vehicle for storage and/or transport.

### CROSS-REFERENCE TO RELATED APPLICATIONS

This application claims priority to U.S. Provisional Patent Application No. 63/463,424 to Gibboney et al., filed May 2, 2023, which is hereby incorporated by reference in its entirety.

### BACKGROUND

### Field of the Invention

This invention relates to powered flight, and more specifically to a vertical take-off and landing aircraft, method, and system.

### Description of Related Art

VTOL capability may be sought after in manned vehicle applications, such as otherwise traditional aircraft. An unmanned aerial vehicle (UAV) is a powered, heavier than air, aerial vehicle that does not carry a human operator, or pilot, and which uses aerodynamic forces to provide vehicle lift, can fly autonomously, or can be piloted remotely. Because UAVs are unmanned, and cost substantially less than conventional manned aircraft, they are able to be utilized in a significant number of operating environments.

UAVs provide tremendous utility in numerous applications. For example, UAVs are commonly used by the military to provide mobile aerial observation platforms that allow for observation of ground sites at reduced risk to ground personnel. The typical UAV that is used today has a fuselage with wings extending outward, control surfaces mounted on the wings, a rudder, and an engine that propels the UAV in forward flight. Such UAVs can fly autonomously and/or can be controlled by an operator from a remote location. UAVs may also be used by hobbyists, for example remote control airplane enthusiasts.

A delivery UAV may have a need to be configured differently depending upon payload mass and/or flight distance. Runways may not always be available, or their use may be impractical. It is often desirable to use a UAV in a confined area for takeoff and landing, which leads to a desire for a craft that can achieve VTOL.

What is needed is delivery UAV which may easily reconfigured for different payload requirements. What is also needed is a UAV which can be easily disassembled, stored, transported, and reassembled.

### SUMMARY

A manned/unmanned aerial vehicle adapted for vertical takeoff and landing which is configured to be easily disassembled and reassembled. The aerial vehicle may be assembled with different wings based upon flight needs, which may be based upon cargo mass and flight duration, for example. The aerial vehicle may utilize structural booms within components, and may allow for decoupling of boom sections to facilitate disassembly. The aerial vehicle may utilize electric motors and store power in batteries. A method of customizing a configuration of an unmanned aerial vehicle based upon flight profile factors such as duration, stability, and maneuverability. A method of disassembling an aerial vehicle for storage and/or transport.

### BRIEF DESCRIPTION OF THE DRAWINGS

FIG. 1 is an upper perspective view of an aerial vehicle according to some embodiments of the present invention.

FIG. 2 is a lower perspective view of an aerial vehicle according to some embodiments of the present invention.

FIG. 3 is a top view of an aerial vehicle according to some embodiments of the present invention.

FIG. 4 is a front view of an aerial vehicle according to some embodiments of the present invention.

FIG. 5 is a side view of an aerial vehicle according to some embodiments of the present invention.

FIG. 6 is a bottom view of an aerial vehicle according to some embodiments of the present invention.

FIG. 7A is an exploded view of an aerial vehicle according to some embodiments of the present invention.

FIG. 7B is a partial hidden line view of an aerial vehicle according to some embodiments of the present invention.

FIG. 7C is a partial hidden line view of an aerial vehicle with hatches open according to some embodiments of the present invention.

FIG. 8 is an upper perspective view of a main body and inner wing assembly according to some embodiments of the present invention.

FIG. 9 is a front view of a main body and inner wing assembly according to some embodiments of the present invention.

FIG. 10 is a top view of a main body and inner wing assembly according to some embodiments of the present invention.

FIG. 11 is a side view of a main body and inner wing assembly according to some embodiments of the present invention.

FIG. 12 is a perspective view of larger wing assemblies according to some embodiments of the present invention.

FIG. 13 is a perspective view of smaller wing assemblies according to some embodiments of the present invention.

FIG. 14 is an upper perspective view of a tail assembly with longitudinal booms according to some embodiments of the present invention.

FIG. 15 is a side view of a tail assembly with longitudinal booms according to some embodiments of the present invention.

FIG. 16 is a top view of a tail assembly with longitudinal booms according to some embodiments of the present invention.

FIG. 17 is a front view of a tail assembly with longitudinal booms according to some embodiments of the present invention.

FIG. 18 is an exploded view of a vertical stabilizer according to some embodiments of the present invention.

FIG. 19 is an exploded view of a horizontal stabilizer according to some embodiments of the present invention.

FIG. 20 is a cross-sectional view of a horizontal stabilizer according to some embodiments of the present invention.

FIG. 21 is an exploded representation of the spars, booms, and joiners according to some embodiments of the present invention.

FIG. 22 is a view of a joining clamp according to some embodiments of the present invention.

FIGS. 23A-D are views of an aerial vehicle with swept wings according to some embodiments of the present invention.

FIGS. 24A-D are views of a swept outer wing with vertical element according to some embodiments of the present invention.

FIGS. 25A-B are views of an aerial vehicle center of mass location according to some embodiments of the present invention.

### DETAILED DESCRIPTION

An aerial vehicle is adapted to be easily reconfigurable with alternate rotor assemblies or alternate outer wings, as may be dictated by flight requirements. In some aspects, the aerial vehicle may be easily disassembled such that the disassembled aerial vehicle may be configured in a very compact manner for storage and/or transport. In some aspects, the aerial vehicle uses longitudinal booms that run through the main body and inner wing assembly, and have forward rotor assemblies on a front end of the longitudinal booms and a tail assembly coupled to the rear end of the longitudinal booms. In some aspects, the aerial vehicle may not have a tail assembly, and have swept back outer wings with vertical elements, with longitudinal booms extending through the wings to forward rotor assemblies. The main body may have spars running transversely within the main body to allow coupling of the inner wings to outer wings which also have spars within them. The rotor assemblies, outer wings, and tail assembly may all be removably coupled to allow for easy disassembly and reassembly. Further, alternate outer wings may be used for different flight requirements. Also, different rotor assemblies may be used for different flight requirements. In some aspects, the outer wings may be rearward swept and include outboard vertical elements, and used in a configuration without a tail assembly.

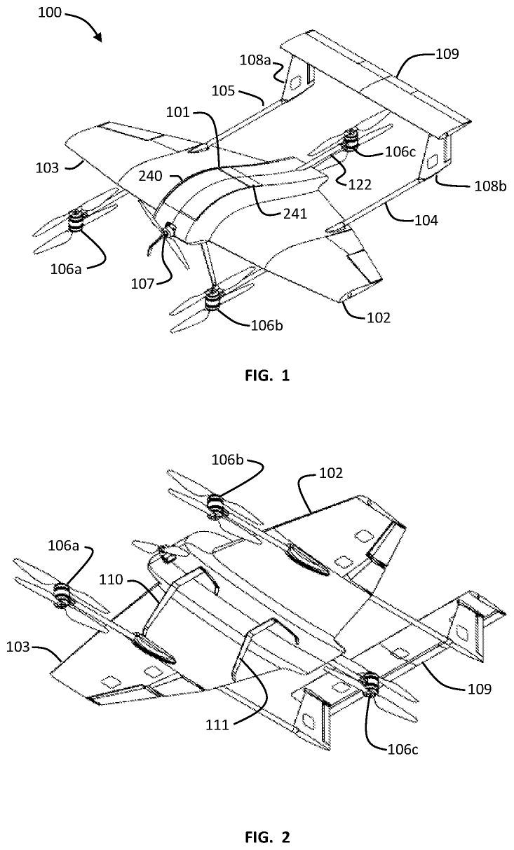

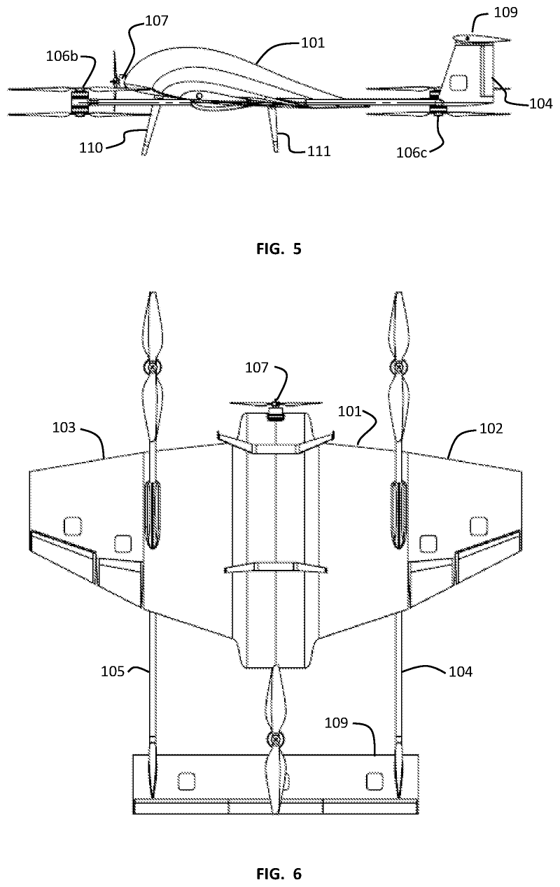

In some embodiments of the present invention, as seen in FIGS. 1-6 an aerial vehicle 100 is seen in a flight ready configuration. The aerial vehicle 100 has a main body and inner wing assembly 101 which may include an internal cargo area. The cargo area may be accessible through a front hatch 240 and a rear hatch 241, which may open to expose the cargo area. A left longitudinal spar 104 and a right longitudinal spar 105 extend both forward and rearward from the main body and inner wing assembly 101. The left longitudinal spar 104 and a right longitudinal spar 105 may run through the main body and inner wing assembly 101 in some aspects. An aft boom 122 is coupled to a rear central area of the main body and inner wing assembly 101.

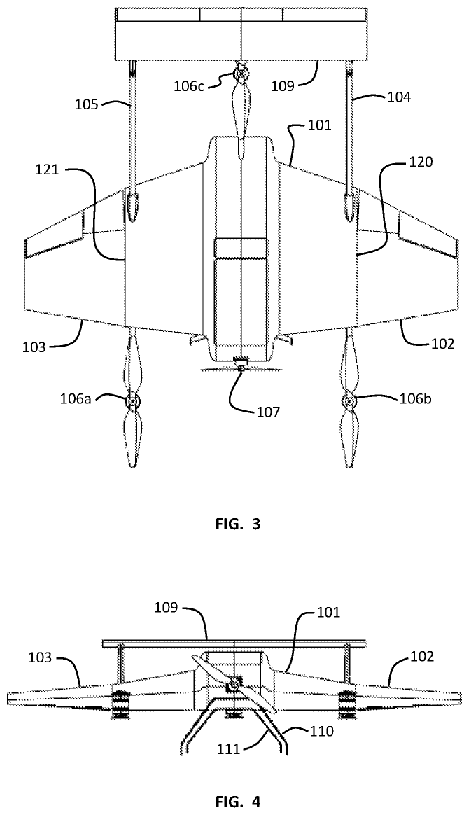

The aerial vehicle 100 is adapted for vertical take-off and landing (VTOL). A right side forward rotor assembly 106a is coupled to a front end of the right side longitudinal boom 105, and a left side forward rotor assembly 106b is coupled to a front end of the left side longitudinal boom 104. A rear rotor assembly 106c is coupled to a rearward end of the aft boom 122. The right side forward rotor assembly 106a, left side forward rotor assembly 106b, and rear rotor assembly 106c are adapted to provide primarily vertical thrust during VTOL operations. In some aspects the rotor assemblies may be clamped onto the booms. In some aspects, the rotor assemblies may be slid onto the booms and pinned in place. In some aspects, other easily mounted and releasable attachments may be used. In an illustrative example, the booms may be cylindrical elements. In some aspects, as better illustrated in FIG. 3, the diameter of the propeller blade swept disc may reside entirely forward of the leading edge of the wings. In some aspects, 90 percent of the diameter of the propeller blade swept disc resides forward of the leading edge of the wings.

A forward flight rotor 107 is seen on the front of the main body and inner wing assembly 101. In an illustrative example, the rotor assemblies 106a, 106b, 106c are engaged for vertical take-off, and the forward flight rotor 107 is engaged to gain forward velocity in transitional flight, and then the rotor assemblies 106a, 106b, 106c may be powered down once forward speed has increased and sufficient lift has been achieved using the wings. In some aspects, the forward velocity in transitional flight may be enhanced by a pitching down of the aerial vehicle in order to gain a forward thrust component from the vertical thrust rotor assemblies.

In an illustrative embodiment, the rotor assemblies 106a, 106b, 106c each have two motors and two propellers stacked in a vertically coaxial fashion. The motors may each be 90 mm in diameter, and 40 mm tall. The propellers may have a diameter of 0.76 m. In this illustrative example, the overall loaded aerial vehicle weight is 25 kg, and each motor uses <550 Watts, for a total of <3300 Watts. The forward flight motor may be 70 mm in diameter, and 40 mm in thickness, and in nominal forward cruise flight may use approximately 700 W.

A right side vertical stabilizer 108a and a left side vertical stabilizer 108b are coupled to the rearward ends of the right side longitudinal boom 105 and the left side longitudinal boom 104, respectively. A horizontal stabilizer 109 is coupled to the upper ends of the right side vertical stabilizer 108a and a left side vertical stabilizer 108b. Further control surfaces may be present, as illustrated in FIG. 1, for example. A forward landing gear 110 and a rearward landing gear 111 support the aircraft while on the ground. The forward landing gear 110 and a rearward landing gear 111 are coupled to an underside of the main body and inner wing assembly 101.

The right side outer wing 103 is coupled to a right side of the main body and inner wing assembly 101. The right side outer wing 103 may include control surfaces. The left side outer wing 102 is coupled to the right side of the main body and inner wing assembly 101. As described further below, the right side outer wing 103 and left side outer wing 102 are easily removable and replaceable. Outer wings of different sizes may be used, and easily incorporated into the aerial vehicle, as desired and as based upon flight needs. The outer wings may include internal spars, which in addition to providing structural strength and rigidity allow for coupling to the main body and inner wing assembly, which itself may have spars within it. Spar joiners, as discussed below, may facilitate the coupling of the outer wings to the main body and inner wing assembly.

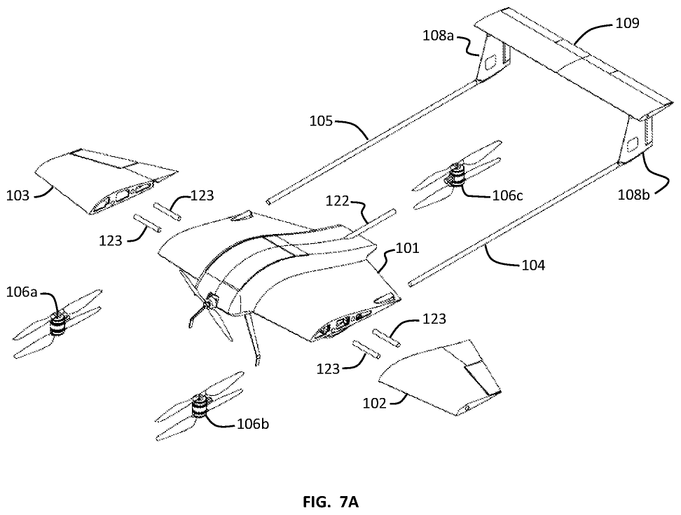

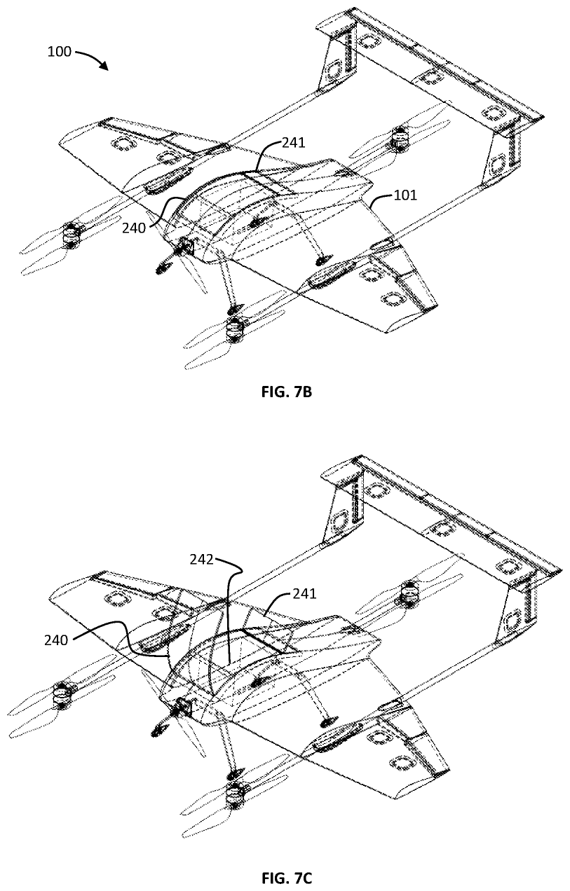

FIG. 7A is an exploded view which illustrates the easily disassemblable, reconfigurable, and reassembleable nature of embodiments of the present invention. In this illustrative view, the right side longitudinal boom 105 and the left side longitudinal boom 104 have been pulled out rearward from the main body and inner wing assembly 101. Prior to their removal rearward, the forward rotor assemblies 106a, 106b have been removed from the front ends of the longitudinal booms. In some aspects, the longitudinal booms pass through clamps within the main body and inner wing assembly which allow for firm structural attachment of the longitudinal booms to the main body and inner wing assembly. In some aspects, the longitudinal booms may pass through mating receivers, such as slip fits tubes. In some aspects, the longitudinal booms may be pinned in place. In some aspects, the longitudinal booms may be otherwise fastened.

FIG. 7B-C provide partial hidden line views which provide insight into aspects of the present invention. A forward hatch 240 and a rear hatch 241 may open to provide access to a cargo area 242.

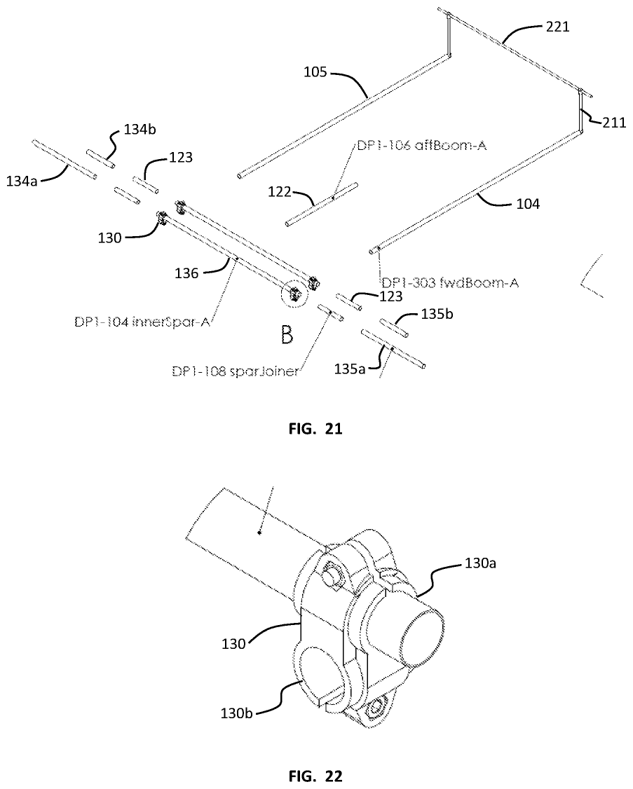

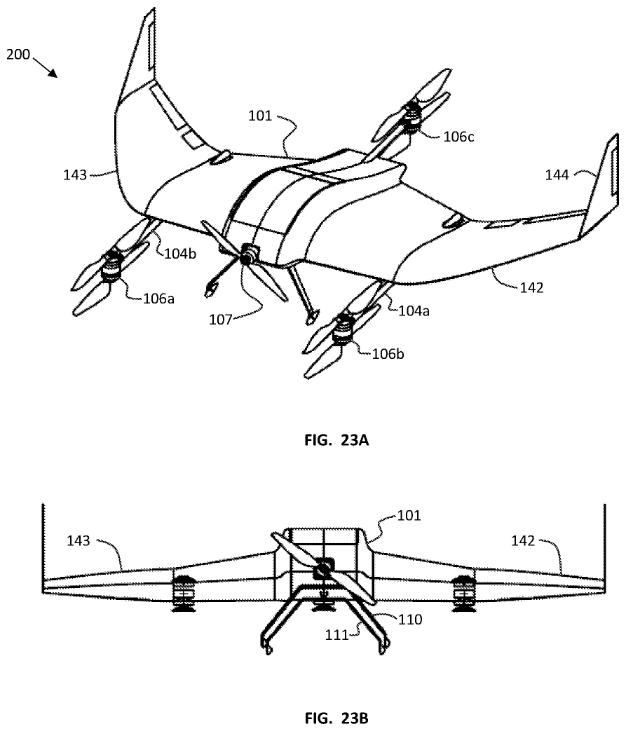

FIG. 21 further illustrates aspects of the boom and spar nature of embodiments of the present invention, and may be viewed in conjunction with FIG. 7. The left wing spars 135a, 135b are adapted to couple to the inner spars 136, which reside within the main body and inner wing assembly. Spar joiners 123 may be used to join the wing spars to the inner spars. The right wing spars 134a, 134b are adapted to couple to the inner spars 136, which reside within the main body and inner wing assembly. Spar joiners 123 may be used to join the wing spars to the inner spars. In some aspects, the spar joiners are slip fit within the inner spars and the outer spars, and are pinned in place. The longitudinal booms may slide through receivers 130b in a coupling clamp 130. Each longitudinal spar 104, 105 may slide through two coupling clamps 130. A coupling clamp 130 may clamped to each of the inner spars 136, which slide through receivers 130a. With this system, the main body, outer wings, forward wing rotor assemblies, rear rotor assembly, and the tail structure are all interconnected with a boom and spar system. This boom and spar aspect allows for proper complete structural coupling of the structural components of the aerial vehicle, while also allowing for quick disassembly for storage, transport, and/or reconfiguration with components of different sizes of capabilities, as needed based upon flight profile demands. The longitudinal booms are adapted for removal from the main body and inner wing assembly 101, and the outer wings, with their internal spars, are coupled to the inner spars of main body using spar joiners. The crossing longitudinal booms and the inner spars of the main body and inner wing assembly are coupled to provide a structurally coupled boom and spar framework for the aerial vehicle. FIG. 22 illustrates the coupling clamps 130 which may be used to structurally couple the crossing booms and spars.

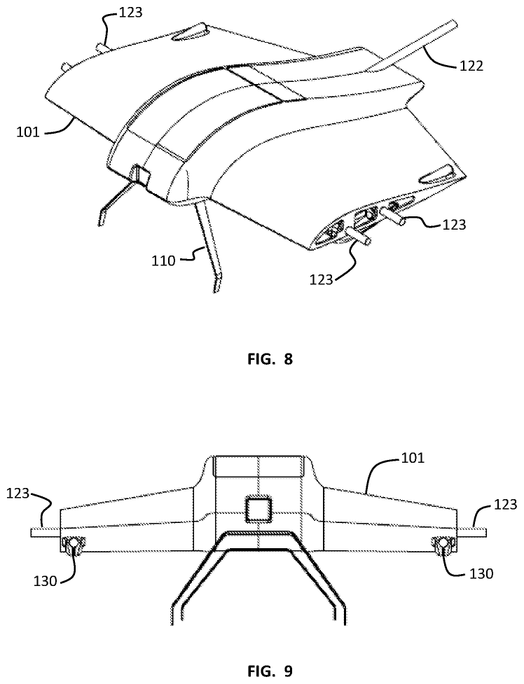

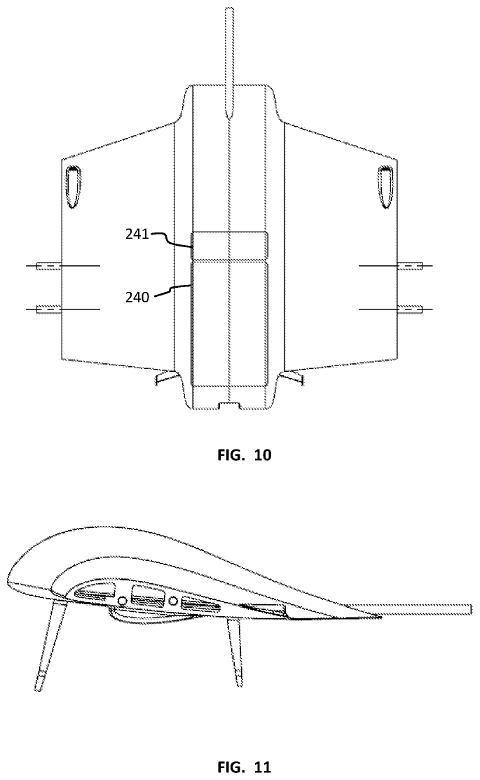

FIGS. 8 and 9 illustrate the main body and inner wing assembly 101 with the aft boom 122 and the spar joiners 123 attached to the main body. The spar joiners 123 are structurally coupled to the inner spars 136, which reside within the main body and traverse the main body horizontally. The coupling clamps 130 provide a routing for the insertion of the longitudinal booms, and then allow for fixed structural coupling of the longitudinal booms to the main body.

In an exemplary embodiment, the power and control wiring for the forward rotors runs through the longitudinal spars, and exits or has a connector at a position which would be adjacent to the main body in a flight configuration. The main body will contain flight electronics, as well as the power source for the motors. In an illustrative example, the power source would be rechargeable batteries, and may be lithium-ion or lithium-polymer batteries. The battery source may be 44 Volts, with 25-30 amp-hours capacity (1100-1300 Watt-hour capacity). Power and control wiring to the outboard wings may cross out from the main body using connectors which blind-mate as the outer wings are coupled to the main body and inner wing assembly.

Based upon factors such as the payload weight, the desire for more stability, the desire for more agility, the desire for speed, the desire for more time aloft, the type of payload, and other factors, the user may configure the aerial vehicle by selection wing sets and/or rotor assemblies which best suit the mission profile. The steps may include assessing the mission profile, selecting wing set types based upon assessment of mission needs, selecting rotor assemblies based upon mission requirements, assembling the aerial vehicle in concert with the identified priorities and needs, and flying the mission.

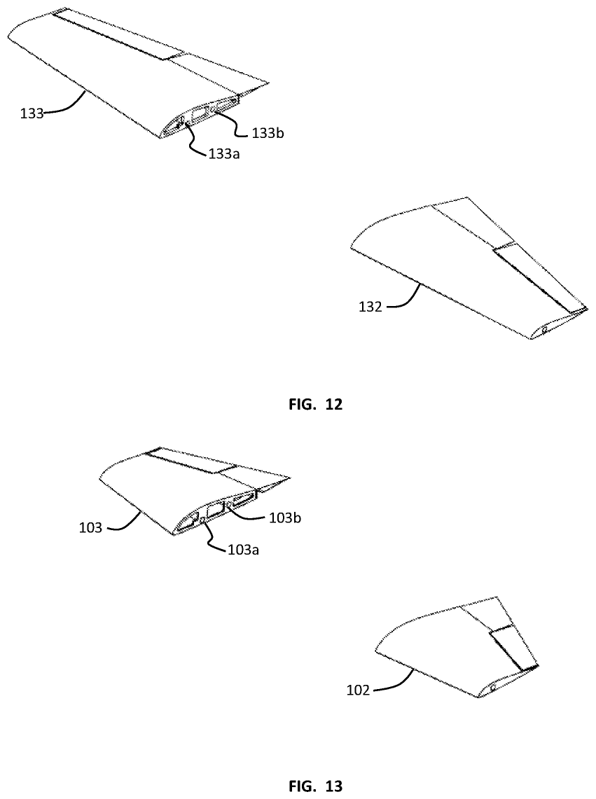

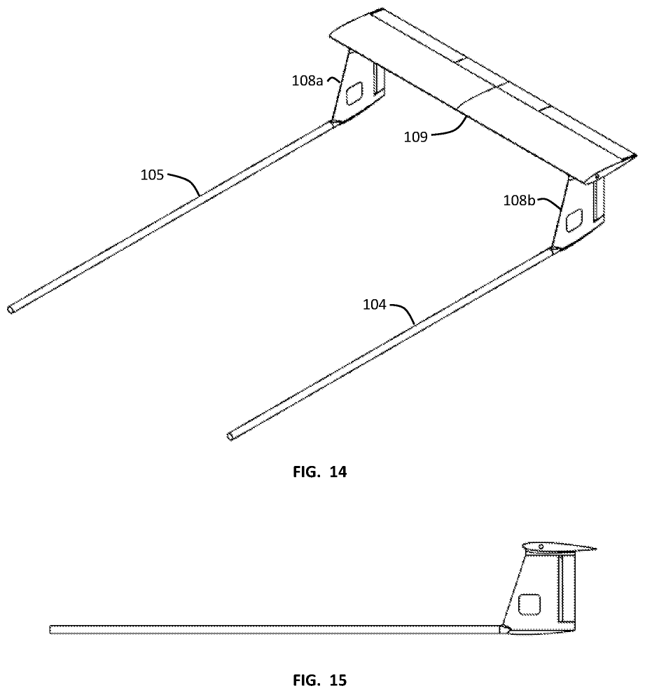

FIGS. 12 and 13 illustrate larger outer wings 132, 133, and smaller outer wings 102, 103, respectively. Using the right side larger outer wing 133 as a representative example, the outer wing 133 may have openings 133a, 133b which provide structural coupling access to the wing spars for the spar couplers. Similarly, the right side smaller outer wing 103 may have openings 103a, 103b which provide structural coupling access to the wing spars of the left wing for the spar couplers.

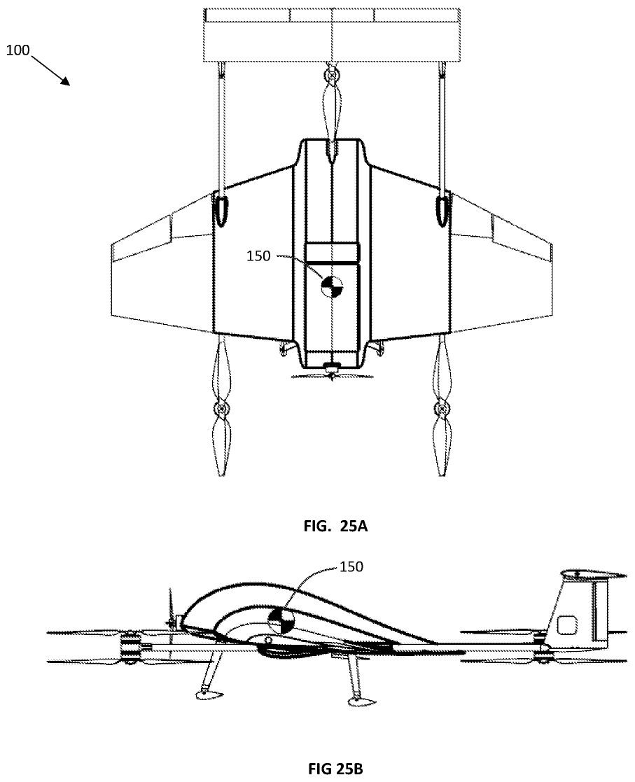

FIGS. 25A-B illustrate a representative center of gravity (CG) location 150 for the aerial vehicle 100. In this representative embodiment, an origin is defined as mid-plane along the forward main spar 136. The CG location may be located at 60 mm aft of the origin, with a CG location range of 60 mm forward of the origin to 120 mm aft of the origin.

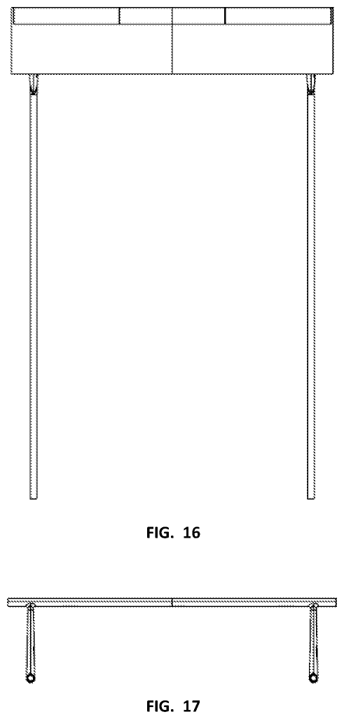

FIGS. 14-17 illustrate a tail assembly coupled to the longitudinal booms according to embodiments of the present invention. The longitudinal spars 104, 105 are coupled to a right side vertical stabilizer 108a and a left side vertical stabilizer 108b, which are then both coupled to a horizontal stabilizer 109. The vertical stabilizers 108a, 108b may include control surfaces. The horizontal stabilizer 109 may include one or more control surfaces.

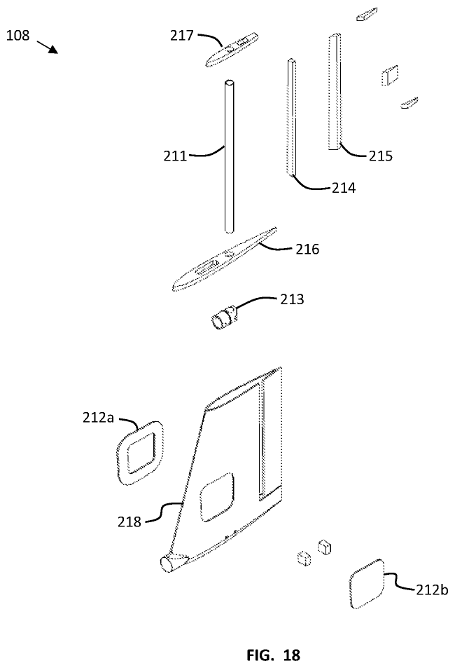

FIG. 18 illustrates an exploded view of a vertical stabilizer 108. A vertical stabilizer spar 211 may extend the vertical length of the vertical stabilizer and be coupled to the longitudinal boom with a coupler 213. Stringers 214, 215 provide additional stability and an upper cap 217 and lower cap 216 reside at the upper end and the lower end of the stabilizer. A vertical stabilizer skin 218 provides the aerodynamic surface for the vertical stabilizer 108. A hatch 212a and cover 212b provide access into the vertical stabilizer, as may be need to install and/or access control mechanism for the control surface or surfaces on the vertical stabilizer.

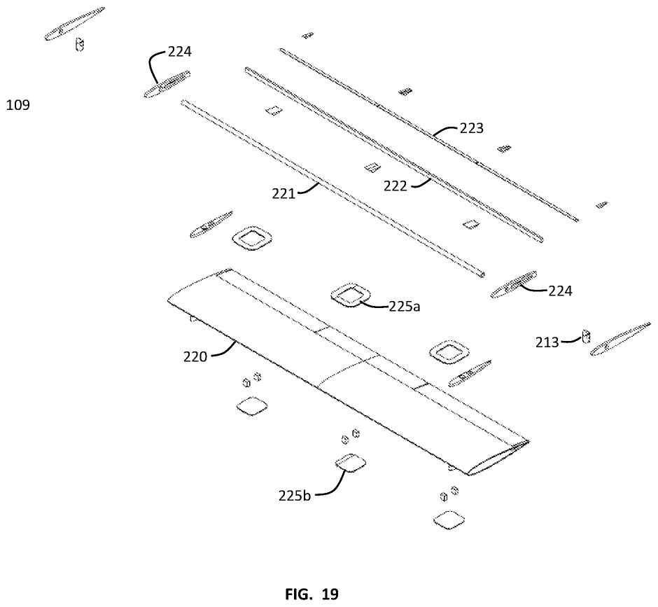

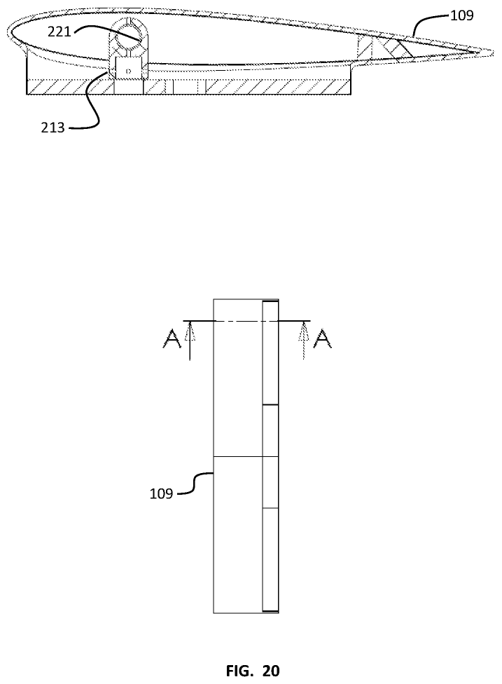

FIG. 19 illustrates an exploded view of a horizontal stabilizer 109. A horizontal stabilizer spar 221 may extend the horizontal width of the horizontal stabilizer and be coupled to the vertical stabilizer spar with a coupler 213. Stringers 221, 222, 223 provide additional stability and outer caps 224 reside at the outer ends of the stabilizer. A horizontal stabilizer skin 220 provides the aerodynamic surface for the horizontal stabilizer 109. Hatches 225a and covers 225b provide access into the horizontal stabilizer, as may be need to install and/or access control mechanism for the control surface or surfaces on the horizontal stabilizer. FIGS. 19 and 20 illustrate a cross-sectional view of the horizontal stabilizer 109 with the horizontal stabilizer spar 221 coupled into the coupler 213, which would then also be coupled to the vertical stabilizer spar 211.

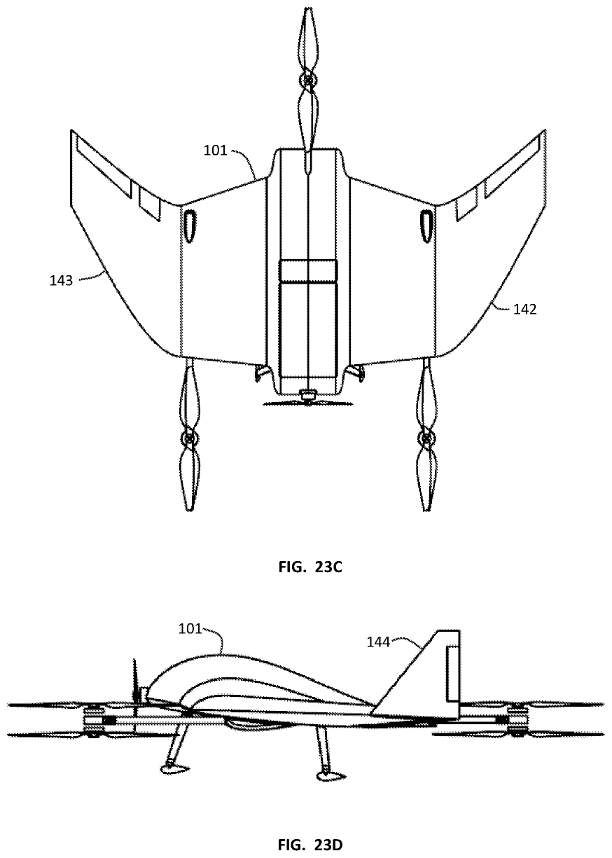

In some embodiments of the present invention, as seen in FIGS. 23A-D, an aerial vehicle 200 is seen in a flight ready configuration. The aerial vehicle 100 has a main body and inner wing assembly 101 which may include an internal cargo area. The cargo area may be accessible through a front hatch 240 and a rear hatch 241, which may open to expose the cargo area. A left longitudinal spar 104a and a right longitudinal spar 105a extend forward from the main body and inner wing assembly 101. In this representative embodiment, the longitudinal spars 104a, 104b do not extend rearward from the main body. The left longitudinal spar 104 and a right longitudinal spar 105 may run through the main body and inner wing assembly 101 in some aspects. An aft boom 122 is coupled to a rear central area of the main body and inner wing assembly 101.

The aerial vehicle 200 does not have a tail assembly, other than the aft boom and rear rotor assembly 106c. In order to provide sufficient attitude control, the aerial vehicle 200 has rearward swept outer wings 142, 143. The rearward swept outer wings 142, 143 provide both stability and control function around the pitch axis of the aerial vehicle. The outer wings 142, 143 include vertical elements 144, 145. The rearward swept outer wing elements 142, 143 may include one or more control surfaces, which may function as ailerons, or other features. As seen in top view in FIG. 23C, the rearward swept wing extends rearward from the main body and inner wing assembly 101, with both the leading edge and the trailing edge of the outer wings 142, 143 sweeping rearward. The control surfaces on the trailing edge are located rearward such that sufficient control of the aerial vehicle may be achieved without a separate tail structure.

The aerial vehicle 200 is adapted for vertical take-off and landing (VTOL). A right side forward rotor assembly 106a is coupled to a front end of the right side longitudinal boom 105, and a left side forward rotor assembly 106b is coupled to a front end of the left side longitudinal boom 104. A rear rotor assembly 106c is coupled to a rearward end of the aft boom 122. The right side forward rotor assembly 106a, left side forward rotor assembly 106b, and rear rotor assembly 106c are adapted to provide primarily vertical thrust during VTOL operations. In some aspects the rotor assemblies may be clamped onto the booms. In some aspects, the rotor assemblies may be slid onto the booms and pinned in place. In some aspects, other easily mounted and releasable attachments may be used. In an illustrative example, the booms may be cylindrical elements. In some aspects, as better illustrated in FIG. 23C, the diameter of the propeller blade swept disc may reside entirely forward of the leading edge of the wings. In some aspects, 90 percent of the diameter of the propeller blade swept disc resides forward of the leading edge of the wings.

A forward flight rotor 107 is seen on the front of the main body and inner wing assembly 101. In an illustrative example, the rotor assemblies 106a, 106b, 106c are engaged for vertical take-off, and the forward flight rotor 107 is engaged to gain forward velocity in transitional flight, and then the rotor assemblies 106a, 106b, 106c may be powered down once forward speed has increased and sufficient lift has been achieved using the wings. In some aspects, the forward velocity in transitional flight may be enhanced by a pitching down of the aerial vehicle in order to gain a forward thrust component from the vertical thrust rotor assemblies.

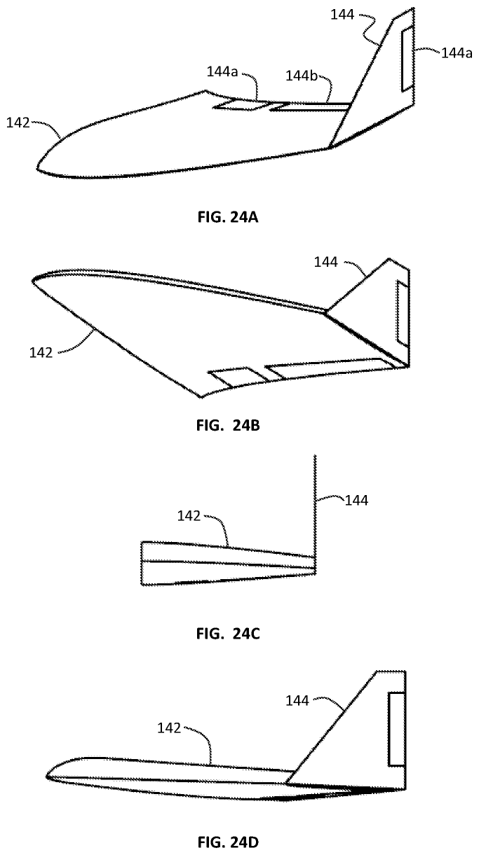

FIGS. 24A-D illustrate a rearward swept outer wing 142, using the right side rearward swept wing as an illustrative example. The outer wing 142 has a rearward swept main airfoil section with a vertical element 144. In some aspects, the vertical element 144 is perpendicular to the horizontal flight path of the aerial vehicle in forward flight. In some aspects, the vertical element 144 is within 15 degrees of perpendicular to the horizontal flight path of the aerial vehicle in forward flight. The main airfoil section of the outer wing may have control surfaces 142a, 142b. The vertical element 144 may have a control surface 144a.

In some aspects, a method for reconfiguring an aerial vehicle may include the steps of removing the right side outer wing, removing the left side outer wing, installing a second right side outer wing of a different type, and installing a second left side outer wing of a different type. The method may further include the steps of removing the forward left side rotor assembly, removing the forward right side rotor assembly, removing the rear rotor assembly, replacing the forward left side rotor assembly with a rotor assembly of a different type, replacing the forward right side rotor assembly with a rotor assembly of a different type, and replacing the rear rotor assembly with a rotor assembly of a different type.

In some aspects, a method of disassembling an aerial vehicle for transport or storage, the method including the steps of removing the right side outer wing, removing the left side outer wing, removing the forward left side rotor assembly, removing the forward right side rotor assembly, removing the rear rotor assembly, removing the left side longitudinal boom, removing the right side longitudinal boom, removing the aft boom, and removing the tail assembly. A method for reassembly of the aerial may include reversing the steps for disassembling the aerial vehicle. In some aspects, the method for disassembling an aerial vehicle for transport or storage would not include removing the tail assembly, such as when disassembling the aerial vehicle 200 which does not have a tail assembly.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. An aerial vehicle, said aerial vehicle comprising:
a main body and inner wing assembly, said main body and inner wing assembly comprising:
a central main body;
a right side inner wing; and
a left side inner wing;
a right side outer wing, said right side outer wing coupled to said right side inner wing;
a left side outer wing, said left side outer wing coupled to said right side inner wing;
a right side longitudinal boom, said right side longitudinal boom traversing through a right side of said main body and inner wing assembly, said right side longitudinal boom extending forward of said main body and inner wing assembly on a front end;
a left side longitudinal boom, said left side longitudinal boom traversing through a left side of said main body and inner wing assembly, said left side longitudinal boom extending forward of said main body and inner wing assembly on a front end;
an aft boom, said aft boom coupled to a central area of said main body and inner wing assembly, said aft boom extending rearward of said main body and inner wing assembly;
a forward right side rotor assembly, said forward right side rotor assembly coupled to said front end of said right side longitudinal boom;
a forward left side rotor assembly, said forward left side rotor assembly coupled to said front end of said left side longitudinal boom; and
a rear rotor assembly, said rear rotor assembly coupled to a rearward end of said aft boom.

2. The aerial vehicle of claim 1 said right side longitudinal boom extends rearward of said main body and inner wing assembly on a rearward end, and wherein said left side longitudinal boom extending rearward of said main body and inner wing assembly on a rearward end, and wherein said aerial vehicle further comprises a tail assembly, said tail assembly coupled to said rearward end of said right side longitudinal boom and to said rearward end of said left side longitudinal boom.

3. The aerial vehicle of claim 2 wherein said main body and inner wing assembly has a plurality of main body lateral spars extending from a right side of said main body and inner wing assembly to a left side of said main body and inner wing assembly, said main body lateral spars structurally coupled to right side longitudinal boom and said left side longitudinal boom.

4. The aerial vehicle of claim 3 wherein said right side outer wing comprises a plurality of right side wing lateral spars, said right side wing lateral spars coupled to said main body spars, and wherein said left side outer wing comprises a plurality of left side wing lateral spars, said left side outer wing lateral spars coupled to said main body spars.

5. The aerial vehicle of claim 2 wherein said tail assembly comprises:
a right side vertical element, a bottom of said right side vertical element coupled to said right side longitudinal boom;
a left side vertical element, a bottom of said left side vertical element coupled to said left side longitudinal boom; and
a horizontal element, said horizontal element coupled to a top of said right side vertical element, said horizontal element coupled to a top of said left side vertical element.

6. The aerial vehicle of claim 1 wherein said right side outer wing is a rearward swept wing, and wherein said left side outer wing is a rearward swept wing.

7. The aerial vehicle of claim 6 wherein said right side outer wing comprises a vertical element at an outboard end, and wherein said left side outer wing comprises a vertical element at an outboard end.

8. The aerial vehicle of claim 2 wherein said right side longitudinal boom is removably coupled to said main body and inner wing assembly, and wherein said left side longitudinal boom is removably coupled to said main body and inner wing assembly.

9. The aerial vehicle of claim 8 wherein said right side forward rotor assembly is removably coupled to said right side longitudinal boom, and wherein said left side forward assembly is removably coupled to said left side longitudinal boom, and wherein said rear rotor assembly is removably coupled to said aft boom.

10. The aerial vehicle wherein said tail assembly is removably coupled to said right side longitudinal boom and said left side longitudinal boom.

11. The aerial vehicle of claim 6 wherein said right side longitudinal boom is removably coupled to said main body and inner wing assembly, and wherein said left side longitudinal boom is removably coupled to said main body and inner wing assembly.

12. The aerial vehicle of claim 11 wherein said right side forward rotor assembly is removably coupled to said right side longitudinal boom, and wherein said left side forward assembly is removably coupled to said left side longitudinal boom, and wherein said rear rotor assembly is removably coupled to said aft boom.

13. The aerial vehicle of claim 6 wherein said aerial vehicle has no tail assembly.

14. The aerial vehicle of claim 12 wherein said aerial vehicle has no tail assembly.

15. A method for the configuring of an aerial vehicle based upon the mission profile needs, the method comprising the steps of:
assessing the mission profile;
selecting wing set types based upon assessment of mission needs;
selecting rotor assemblies based upon mission requirements;
assembling the aerial vehicle in concert with the identified priorities and needs; and
flying the mission.

16. The method of claim 15 wherein the step of selecting wing set types comprises selecting a shorter or a longer outer wing.

17. The method of claim 15 wherein the step of assembling the aerial vehicle comprises removably coupling spars and booms of the aerial vehicle components.

18. A method for the reconfiguring of an aerial vehicle, said method comprising the steps of:
removing the right side outer wing from a main body and inner wing assembly;
removing the left side outer wing from said main body and inner wing assembly;
installing a second right side outer wing of a different type;
and installing a second left side outer wing of a different type.

19. The method of claim 18 wherein said outer wings are removably coupled to said main body and inner wing assembly.

20. The method of claim 19 further comprising the steps of:
removing the forward left side rotor assembly;
removing the forward right side rotor assembly;
removing the rear rotor assembly;
replacing the forward left side rotor assembly with a rotor assembly of a different type;
replacing the forward right side rotor assembly with a rotor assembly of a different type; and
replacing the rear rotor assembly with a rotor assembly of a different type.
